(19) United States
(12) Patent Application Publication
(10) Pub. No.: US 2015/0219126 A1
(43) Pub. Date: Aug. 6, 2015

(54) Multi-Function Hydraulic Hybrid Swing Circuit

(71) Applicant: Caterpillar Inc., Peoria, IL (US)

(72) Inventors: Jiao Zhang, Naperville, IL (US); Michael R. Schwab, Crest Hill, IL (US)

(73) Assignee: Caterpillar Inc., Peoria, IL (US)

(21) Appl. No.: 14/174,543

(22) Filed: Feb. 6, 2014

(51) Int. Cl. F15B 15/24

(52) U.S. Cl. CPC F15B 15/24

(57) ABSTRACT

There is provided a multi-function hydraulic hybrid swing circuit including a fluid source, swing circuit and swing supply circuit. The swing supply circuit includes at least one accumulator and a pump/motor operatively connected to a power source. The pump/motor is fluidly connected to the swing circuit, the accumulator, and the fluid source. The pump/motor is configured to provide both closed loop and open loop operation with the swing circuit.

### TECHNICAL FIELD

The present disclosure relates generally to a hydraulic control system and, more particularly, to a hydraulic control system having swing energy recovery.

### BACKGROUND

Swing-type excavation machines, for example hydraulic excavators and front shovels, require significant hydraulic pressure and flow to transfer material from a dig location to a dump location. These machines direct the high-pressure fluid from an engine-driven pump through a swing motor to accelerate a loaded work tool at the start of each swing, and then restrict the flow of fluid exiting the motor at the end of each swing to slow and stop the work tool.

One problem associated with this type of hydraulic arrangement involves efficiency. In particular, the fluid exiting the swing motor at the end of each swing is under a relatively high pressure due to deceleration of the loaded work tool. Unless recovered, energy associated with the high-pressure fluid may be wasted. Various hydraulic hybrid circuits have been utilized to recover and reuse kinetic energy generated during operation of such machines. In addition, restriction of this high-pressure fluid exiting the swing motor at the end of each swing can result in heating of the fluid, which must be accommodated with an increased cooling capacity of the machine. As a result, such hydraulic hybrid circuits may require significant space in the machine, resulting in larger machines or the inability to utilize such hybrid circuits in smaller machines. Moreover, the operation of such circuits may result in inefficiencies that limit productivity.

One attempt to improve the efficiency of a swing-type machine is disclosed in Japanese application publication JP2011-220390A, which is assigned to Kobelco. The disclosed control device for a hydraulic machine seeks to increase energy regenerative efficiency while securing the anti-cavitation action via a regenerative motor. An accumulator in a hydraulic excavator is arranged as a hydraulic pressure source for anti-cavitation. In turning deceleration, while rotating a regenerative motor by regenerative oil taken out of the meter-out side of a turning motor, the oil of the accumulator is supplied as anti-cavitation oil to the meter-in side of the turning motor via a control valve.

### SUMMARY

The disclosure describes in one aspect, a multi-function hydraulic hybrid swing circuit for movement of fluid. The multi-function hydraulic hybrid swing circuit includes a fluid source, a swing circuit and a swing supply circuit. The swing supply circuit includes at least one accumulator, a pump/motor operatively connected to a power source. The pump/motor is fluidly connected to the swing system, the accumulator, and the fluid source. The swing supply circuit additionally includes at least one accumulator valve regulating flow between the accumulator and the pump/motor, at least one drain valve regulating flow between the fluid source and the pump/motor, and at least one valve regulating flow between the pump/motor and the swing circuit. The pump/motor is configured to provide closed loop operation with the swing circuit, the pump/motor circulating fluid through the swing circuit. The pump/motor is also configured to provide open loop operation with the swing circuit.

According to another aspect of the disclosure, there is provided a machine including a frame and an undercarriage member. The frame is rotatably coupled to the undercarriage member along a vertical axis. The machine also includes an implement system coupled to the frame, a fluid source, fluid, and a multi-function hydraulic hybrid swing circuit for movement of fluid. The multi-function hydraulic hybrid swing circuit includes a swing circuit and a swing supply circuit. The swing supply circuit includes at least one accumulator and a pump/motor operatively connected to a power source. The pump/motor is fluidly connected to the swing circuit, the accumulator, and the fluid source. The swing supply circuit additionally includes at least one accumulator valve regulating flow between the accumulator and the pump/motor, at least one drain valve regulating flow between the fluid source and the pump/motor, and at least one valve regulating flow between the pump/motor and the swing circuit. The pump/motor is configured to provide closed loop operation with the swing circuit, the pump/motor circulating fluid through the swing circuit. The pump/motor also is configured to provide open loop operation with the swing circuit.

According to yet another aspect of the disclosure, a method is provided for use in a multi-function hydraulic hybrid swing circuit for movement of fluid. The multi-function hydraulic hybrid swing circuit including a swing circuit, a swing supply circuit, and a fluid source. The fluid source includes a tank. The swing supply circuit includes at least one accumulator and a pump/motor operatively connected to a power source. The pump/motor is fluidly connected to the swing circuit, the accumulator, and the fluid source. At least one accumulator valve regulates flow between the accumulator and the pump/motor; at least one drain valve regulates flow between the fluid source and the pump/motor; and at least one valve regulates flow between the pump/motor and the swing circuit. The method includes operating the pump/motor to provide closed loop operation with the swing circuit, the pump/motor circulating fluid through the swing circuit; and operating the pump/motor to provide open loop operation with the swing circuit.

### BRIEF DESCRIPTION OF THE DRAWING(S)

FIG. 1 is a diagrammatic illustration of an exemplary disclosed machine operating at a worksite with a haul vehicle;

FIG. 2 is a schematic illustration of an exemplary disclosed hydraulic control system that may be used with the machine of FIG. 1;

FIG. 3 is a diagram depicting an exemplary disclosed method that may be performed by the hydraulic control system of FIG. 2.

### DETAILED DESCRIPTION

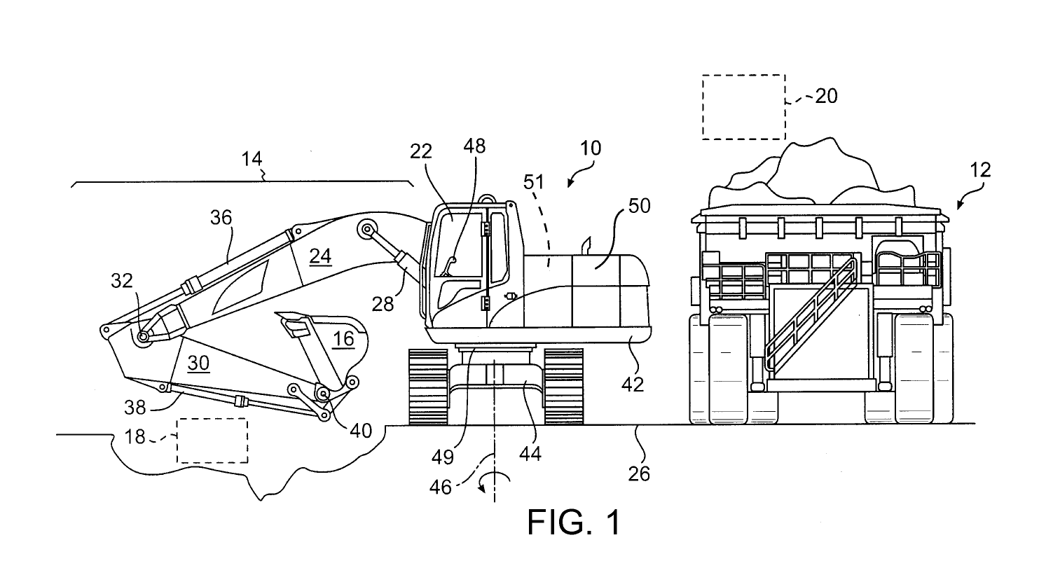

FIG. 1 illustrates an exemplary machine 10 having multiple systems and components that cooperate to excavate and load earthen material onto a nearby haul vehicle 12. In the depicted example, machine 10 is a hydraulic excavator. It is contemplated, however, that machine 10 could alternatively embody another swing-type excavation or material handling machine, such as a backhoe, a front shovel, a dragline excavator, or construction, mining or forestry equipment with a swing sub-system, or another similar machine.

Machine 10 may include, among other things, an implement system 14 configured to move a work tool 16 between a dig location 18 within a trench or at a pile, and a dump location 20, for example over haul vehicle 12. Machine 10 may also include an operator station 22 for manual control of implement system 14. It is contemplated that machine 10 may perform operations other than truck loading, if desired, such as craning, trenching, material handling, and pipe laying.

Implement system 14 may include a linkage structure acted on by fluid actuators to move work tool 16. Specifically with regard to the illustrated machine 10, implement system 14 may include a boom 24 that is vertically pivotal relative to a work surface 26 by a pair of adjacent, double-acting, hydraulic cylinders 28 (only one shown in FIG. 1). Implement system 14 may also include a stick 30 that is vertically pivotal about a horizontal pivot axis 32 relative to boom 24 by a single, double-acting, hydraulic cylinder 36. Implement system 14 may further include a single, double-acting, hydraulic cylinder 38 that is operatively connected to work tool 16 to tilt work tool 16 vertically about a horizontal pivot axis 40 relative to stick 30. Boom 24 may be pivotally connected to a frame 42 of machine 10, while frame 42 may be pivotally connected to an undercarriage member 44 and swung about a vertical axis 46 by a swing motor 49. Stick 30 may pivotally connect work tool 16 to boom 24 by way of pivot axes 32 and 40. It is contemplated that a greater or lesser number of fluid actuators may be included within implement system 14 and connected in a manner other than described above, if desired.

Numerous different work tools 16 may be attachable to a single machine 10 and controllable via operator station 22. Work tool 16 may include any device used to perform a particular task such as, for example, a bucket, a fork arrangement, a blade, a shovel, a crusher, a shear, a grapple, a grapple bucket, a magnet, or any other task-performing device known in the art. Although connected in the embodiment of FIG. 1 to lift, swing, and tilt relative to machine 10, work tool 16 may alternatively or additionally rotate, slide, extend, open and close, or move in another manner known in the art.

Operator station 22 may be configured to receive input from a machine operator indicative of a desired work tool movement. Specifically, operator station 22 may include one or more input devices 48 embodied, for example, as single or multi-axis joysticks located proximal an operator seat (not shown). Input devices 48 may be proportional-type controllers configured to position and/or orient work tool 16 by producing a work tool position signal that is indicative of a desired work tool speed and/or force in a particular direction. The position signal may be used to actuate any one or more of hydraulic cylinders 28, 36, 38 and/or swing motor 49. It is contemplated that different input devices may alternatively or additionally be included within operator station 22 such as, for example, wheels, knobs, push-pull devices, switches, pedals, and other operator input devices known in the art. For the purposes of this disclosure, the term “input device” is intended to include all such devices. Input devices 48 as well as various sensors and the like, such as those discussed herein may provide command signals and input to one or more controllers 51 that provide signals for operation of the machine 10 and its systems.

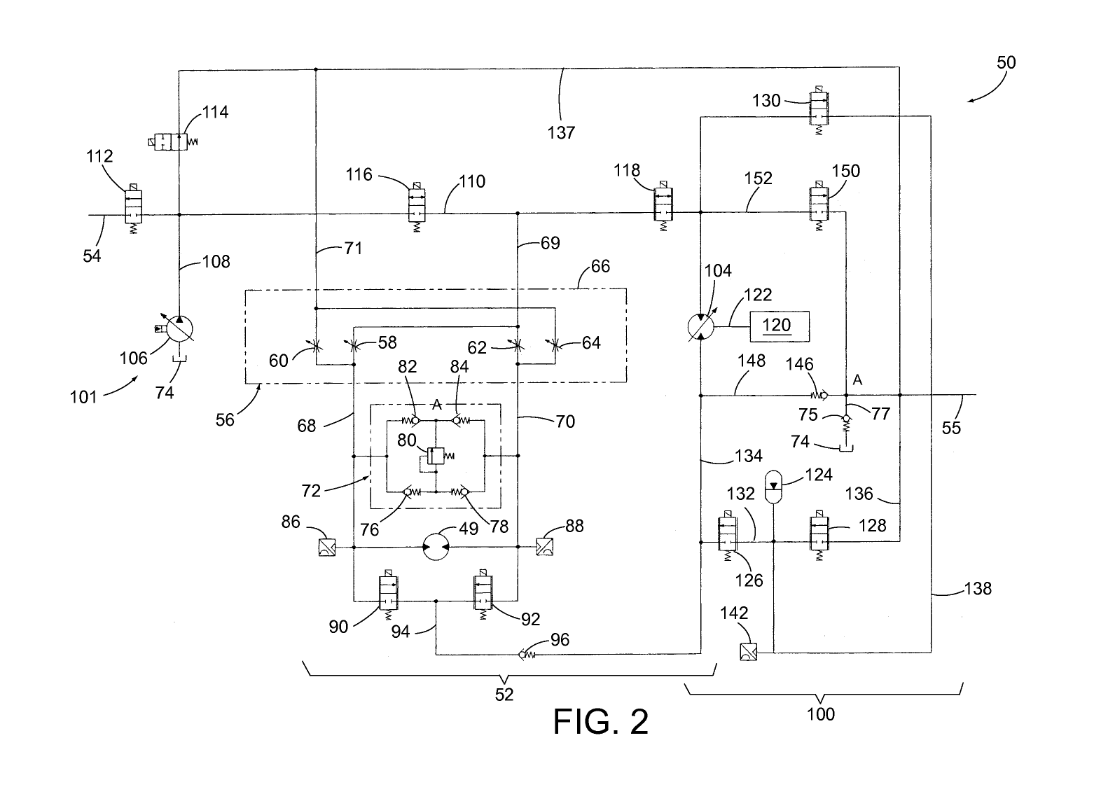

The machine 10 may include a multi-function hydraulic hybrid swing circuit 50, a portion of which is illustrated in FIG. 2, having a plurality of fluid components that cooperate to move implement system 14 (referring to FIG. 1). In particular, multi-function hydraulic hybrid swing circuit 50 may include a swing circuit 52 associated with swing motor 49, and typically at least a second circuit associated with hydraulic cylinders 28, 36, and 38 (see FIG. 1) and/or other hydraulic components or systems. Such a second circuit may include various control valves, for example, a boom control valve (not shown), a stick control valve (not shown), a tool control valve (not shown), a travel control valve (not shown), and/or an auxiliary control valves, thereby regulating the corresponding actuators (e.g., hydraulic cylinders 28, 36, and 38). The second circuit may be supplied from the illustrated multi-function hydraulic hybrid swing circuit 50 at supply line 54, and/or may include additional pumps, motors, and supplies. Fluid may be returned from the second circuit to the illustrated multi-function hydraulic hybrid swing circuit 50 at return line 55.

The multi-function hydraulic hybrid swing circuit 50 may be in fluid communication with a fluid source that may include one or more tanks 74 and fluid within or returned to the multifunction hydraulic hybrid swing circuit 50, for example, at return line 55 to junction A. Tank 74 may constitute a reservoir configured to hold a low-pressure supply of fluid. The fluid may include, for example, dedicated hydraulic oil, engine lubrication oil, transmission lubrication oil, or any other fluid known in the art. One or more hydraulic systems within machine 10 may draw fluid from and return fluid to tank 74. It is contemplated that the swing circuit 52, and more generally, the multi-function hydraulic hybrid swing circuit 50, may be connected to multiple separate fluid tanks or to a single tank, as desired. A check valve 75 may be disposed within drain passage 77, if desired, to promote a unidirectional flow of fluid into tank 74 and to provide back pressure at junction A.

The swing circuit 52 may include, among other things, a swing control valve 56 connected to regulate a flow of pressurized fluid to and from swing motor 49 to control the rotation of swing motor 49 in first and second directions, and, accordingly, corresponding swinging motion of the implement system 14 (referring to FIG. 1) in accordance with an operator request received via input device 48. As in the illustrated embodiment, swing control valve 56 may include a first chamber supply element 58, a first chamber drain element 60, a second chamber supply element 62, and a second chamber drain element 64, which all may be disposed within a common block or housing 66. It is contemplated that both the supply and drain functions of swing control valve 56 (i.e., of the four different supply and drain elements) may alternatively be performed by a single valve element associated with the first chamber and a single valve element associated with the second chamber, or by a single valve element associated with both the first and second chambers, if desired.

Supply and drain elements 58, 60, 62, 64 of swing control valve 56 may be solenoid-movable against a spring bias in response to a flow rate and/or position command issued by a controller 51. In particular, swing motor 49 may rotate at a velocity that corresponds with the flow rate of fluid into and out of the first and second chambers. Accordingly, to achieve an operator-desired swing torque, a command based on an assumed or measured pressure differential may be sent to the solenoids (not shown) of supply and drain elements 58, 60, 62, 64 that causes them to open an amount corresponding to the necessary fluid pressure at swing motor 49. This command may be in the form of a flow rate command or a valve element position command that is issued by a controller 51.

The swing control valve 56 is coupled to the swing motor 49 at conduits 68, 70. The first chamber supply element 58 and first chamber drain element 60 may be fluidly connected by conduit 68 to regulate flow to and drainage from the swing motor 49, while the second chamber supply element 62 and second chamber drain element 64 are fluidly connected by conduit 70 to regulate flow to and drainage from the swing motor 49. The swing control valve 56 is further coupled to supply passage 69 and drain passage 71.

Swing circuit 52 may additionally include built-in makeup and relief functionality. In this regard, the swing circuit 52 may include a crossover relief and make-up unit 72 fluidly disposed between the swing control valve 56 and the swing motor 49. The illustrated design is provided by way of example only, and an alternate design may be provided. In the illustrated embodiment, junction A within the crossover relief and make-up unit 72 is fluidly connected at junction A adjacent a tank 74. One or more flow regulators, here in the form of opposed check valves 76, 78 may provide relief flow from conduits 68, 70, respectively, to relief valve 80 to junction A and on to tank 74 under predetermined circumstances based upon associated pressure differentials. Similarly, one or more flow regulators, here in the form of opposed check valves 82, 84 may provide make-up flow to conduits 68, 70, respectively, from junction A, again, under predetermined circumstances based upon associated pressure differentials.

The swing circuit 52 may include additional valves, conduits, and sensors. For example, the swing circuit 52 may further include one or more pressure sensors 86, 88 strategically located within conduits 68, 70 to sense a pressure of the respective conduits and generate a corresponding signal indicative of the pressure directed to the controller 51. Further, the swing circuit 52 may include flow control valves, such as selector valves 90, 92, which control flow from conduits 68, 70 to drain line 94, and flow control valve 96, which controls flow through the drain line 94. The flow control valve 96 may be, for example, a check valve.

The illustrated selector valves 90, 92 may be normally closed, operable by way of, for example, a solenoid. Valves 90, 92 are moveable from a closed position that prevents the flow of fluid between ports along either side of the respective valve toward an open position that permit flow between the ports. Inasmuch as the illustrated valves 90, 92 are variable position, as the respective valve element moves from the normally closed position, i.e., a position wherein flow of fluid is blocked, flow may be established through an internal opening (not specifically illustrated, but understood by those of skill in the art), the flow being dependent, at least in part, by the size of the opening as the valve element moves from the closed position. For the purposes of this disclosure, with regard to valve operation and structure, the terms “closed” and “closed position” will refer to a position in which flow of fluid through the valve is blocked, and the terms “open” and “open position” will refer to any position in which fluid flow through the valve is not blocked.

To drive swing motor 49 to rotate in a first direction, flow may be provided from supply passage 69 to the first chamber supply element 58 to allow pressurized fluid from the supply passage 69 via conduit 68 to the first chamber of swing motor 49. Fluid may flow from the swing motor 49 via conduit 70 and second chamber drain element 64 to drain passage 71, or fluid may flow from the swing motor 49 to drain line 94 if valve 92 is disposed in an open position. Similarly, to drive swing motor 49 to rotate in the opposite direction, fluid may be supplied from supply passage 69 through second chamber supply element 62 via conduit 70 to swing motor 49. Likewise, fluid may flow from the swing motor 49 via conduit 68 and first chamber drain element 60 to drain passage 71, or fluid may flow from swing motor 49 to drain line 94 if valve 90 is disposed in an open position.

Fluid may be supplied to the swing circuit 52 by the swing supply circuit 100, or, optionally, a implement supply circuit 101. The implement supply circuit 101 may include a source of fluid under pressure, such as an implement pump 106, which may supply fluid from a tank 74 to the implement system 14 by way of supply line 54. In the illustrated embodiment, the implement pump 106 may additionally supply pressurized fluid from the tank 74 through conduit 108 to supply line 110 to supply passage 69. One or more valves 112, 114, 116, 118 may be provided to direct flow of fluid to the line 54, 136, 110, or passage 69.

According to an aspect of the disclosure, the swing supply circuit 100 includes an arrangement that may provide fluid flow to the swing circuit 52 from the tank 74, as well as from and/or to at least one accumulator 124 by way of a pump/motor 104 and a plurality of conduits and valves (discussed in greater detail below), operable to provide the various functions of the multi-function hydraulic hybrid swing circuit 50.

The pump/motor 104 may be drivably connected to a power source, such as an engine 120 by, for example, a countershaft, a belt, an electrical circuit, or in another suitable manner. Alternatively, pump/motor 104 may be indirectly connected to the power source or engine 120 of machine 10 via a torque converter, a reduction gear box, an electrical circuit, or in any other suitable manner (not shown). The connection between the power source or engine 120 and the pump/motor 104 is shown generally as reference number 122.

The swing supply circuit 100 additionally includes at least one accumulator 124 configured to receive or supply fluid by way the swing supply circuit 100. Selector valves 126, 128, 130 or the like may be disposed in lines 132, 134, 136, 138, 94 leading to/from the accumulator to control the flow of fluid to or from the accumulator 124, the pump/motor 104, the tank 74, and the swing circuit 52. Each of the selector valves 126, 128, 130 is moveable from a closed position that prevents the flow of fluid between the respective valve ports toward an open position that permit flow between the ports.

The swing supply circuit 100 may include additional flow control devices, conduits, and sensors. For example, the swing supply circuit 100 may further include one or more pressure sensors 142 strategically located within lines or conduits, such as line 138 to sense a pressure within the respective line and generate a corresponding signal indicative of the pressure directed to the controller 51. Further, the swing supply circuit 100 may include flow control valves, such as check valves 144, 146, which control directional flow through lines 94, and 148, respectively, and/or selector valve 150, which controls flow through line 152.

The illustrated selector valves 126, 128, 130, 150 may be normally closed, operable by way of, for example, a solenoid. Valves 126, 128, 130, 150 are moveable from a closed position that prevents the flow of fluid between ports along either side of the respective valve toward an open position that permit flow between the ports. Inasmuch as the illustrated valves 126, 128, 130, 150 are variable position, as the respective valve element moves from the normally closed position, i.e., a position wherein flow of fluid is blocked, flow may be established through an internal opening (not specifically illustrated, but understood by those of skill in the art), the flow being dependent, at least in part, by the size of the opening as the valve element moves from the closed position.

The controller 51 (shown schematically in FIG. 1) of this disclosure may be of any conventional design having hardware and software configured to perform the calculations and send and receive appropriate signals to perform the disclosed logic. The controller 51 may include one or more controller units, and may be configured solely to perform the disclosed strategy, or to perform the disclosed strategy and other processes of the machine 10. The controller 51 may be of any suitable construction, and may include a processor (not shown) and a memory component (not shown). The processor may be microprocessors or other processors as known in the art. In some embodiments the processor may be made up of multiple processors. For example, the controller may comprise a digital processor system including a microprocessor circuit having data inputs and control outputs, operating in accordance with computer-readable instructions stored on a computer-readable medium. Typically, the processor will have associated therewith long-term (non-volatile) memory for storing the program instructions, as well as short-term (volatile) memory for storing operands and results during (or resulting from) processing.

The processor may execute instructions for operation of components of the multi-function hydraulic hybrid swing circuit 50, including operation of the pump/motor 104, implement pump 106, and various valves. Such instructions may be read into or incorporated into a computer readable medium, such as the memory component or provided external to processor. In alternative embodiments, hard-wired circuitry may be used in place of or in combination with software instructions. Thus, embodiments are not limited to any specific combination of hardware circuitry and software.

The term “computer-readable medium” as used herein refers to any medium or combination of media that participates in providing instructions to processor for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer or processor can read.

The memory component may include any form of computer-readable media as described above. The memory component may include multiple memory components.

The controller 51 may be enclosed in a single housing. In alternative embodiments, the controller 51 may include a plurality of components operably connected and enclosed in a plurality of housings.

### INDUSTRIAL APPLICABILITY

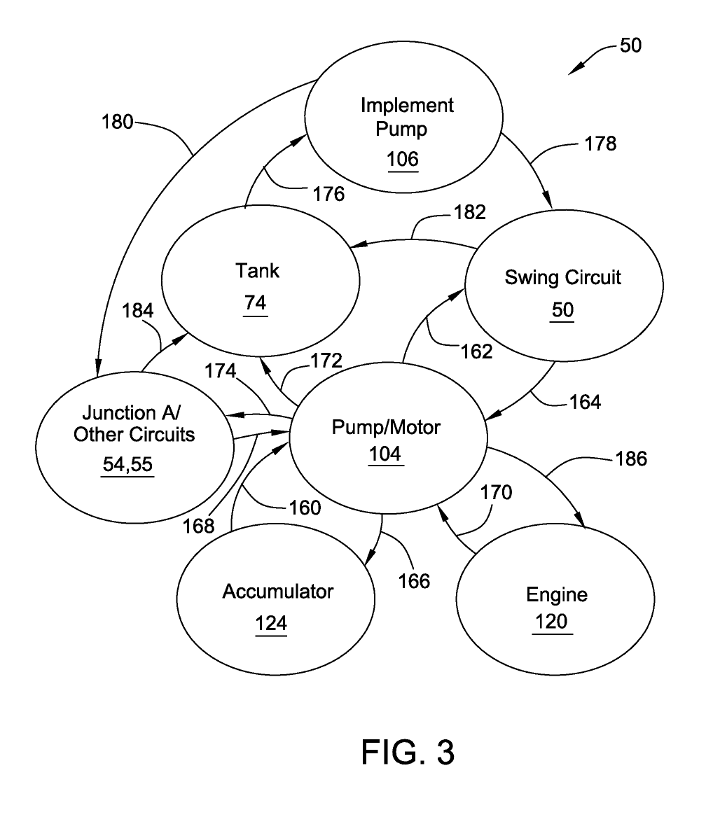

According to an aspect of the disclosure, the multi-function hydraulic hybrid swing circuit 50 is adapted to perform both open loop and closed loop operations, as well as power peak shaving operations. FIG. 3 schematically illustrates the operation of the multi-function hydraulic hybrid swing circuit 50. The pump/motor 104 may be utilized in both open and closed loop operations, as well as power shaving operations.

In primary swing operations, powered by the engine 120 (see directional arrow 170), the pump/motor 104 may pump fluid to the swing circuit 52 in a closed loop operation (see directional arrows 162, 164). Referring to FIG. 2, the pump/motor 104 may provide fluid through an open valve 118 to supply passage 69 to the swing control valve 56. Depending upon the position of the swing control valve 56, fluid is supplied to conduit 68 or 70 and to the swing motor 49 to provide a desired swing. Fluid is returned through one of valves 90 and 92, line 94, and check valve 144 for continued circulation by the pump/motor 104.

Returning to FIG. 3, again, powered by the engine 120 (see directional arrow 170), the pump/motor may provide fluid to the hydraulic hybrid swing circuit 50 (see directional arrow 162) from the junction A (see directional arrow 168) or from the accumulator 124 (see directional arrow 160) in open loop operation. It will be appreciated that fluid at junction A may include, for example, fluid returned from other circuits via return line 55, from the swing control valve 56 via line 137, implement pump 106 via lines 137 or 152, or the pump/motor 104 via line 152.

In open loop operation, operation of the pump/motor 104 providing fluid to the swing circuit 52 ultimately returns fluid from the swing circuit 52 to the tank (see directional arrow 172). For example, referring to FIG. 2, via line 132, the pump motor 104 may be provided fluid from the accumulator 124 through open valve 126 in line 132 and through line 134 or from junction A through line 148 to line 134. In this way, the pump/motor 104 pumps fluid through open valve 118 to supply passage 69 to the swing control valve 56. As explained above, depending upon the position of the swing control valve 56, fluid is supplied to conduit 68 or 70 and to the swing motor 49 to provide a desired swing. Fluid proceeding through the swing motor 49 is returned through the other of conduit 68 or 70, through the swing control valve 56 to drain passage 71 to be returned to the tank 74.

Returning to FIG. 3, the multi-function hydraulic hybrid swing circuit 50 provides operational flexibility in that, the pump/motor 104 may likewise be utilized to provide fluid to other circuits by way of supply line 54 (see directional arrow 174) in the illustrated embodiment, i.e., in open loop operation if required. Similarly, under appropriate conditions, the implement pump 106 may be utilized to provide fluid from the tank 74 (see directional arrow 176) to either the swing circuit 52 (see directional arrow 178) or to other circuits by way of supply line 54 (see directional arrow 180). For example, referring to FIG. 2, the implement pump 106 may provide fluid from the tank 74 through conduit 108 and open valve 116 to supply passage 69 to the swing control valve 56 and swing motor 49, returning though the swing control valve 56 and drain passage 71. Referring to FIG. 3, in this open loop operation, fluid from the swing circuit 52 may be returned to the tank 74 (see directional arrow 182), and fluid from the other circuits may be returned the tank 74 (see directional arrow 184), for example, via return line 55.

The pump/motor 104 may likewise be utilized during swing deceleration. For example, the pump/motor 104 may be utilized in charging the accumulator 124 (see directional arrow 166) during swing deceleration, which is referred to as the pump/motor in loop charge. Under conditions where the accumulator 124 is fully charged, the pump/motor 104 may be utilized in providing fluid to other circuits, for example, by way of the supply line 54 (see directional arrow 174). Referring to FIG. 2, fluid from the swing motor 49 proceeding through either valve 90 or 92 to line 94, is pumped by the pump/motor 104 from line 134, through open valve 130 and line 138 to the accumulator 124. Under circumstances where the accumulator 124 is fully charged, or in addition to charging the accumulator through open valve 126, the pump/motor 104 may pump fluid through open valves 118, 116, and 112 and supply line 54 to other circuits. Also, the pump/motor 104 may be connected to the tank 74 through line 152 and open valve 150 through junction A, drain passage 77 and check valve 75.

According to another aspect of the disclosure, the multifunction hydraulic hybrid swing circuit 50 may be utilized in power peak shaving operations. Under such conditions, the engine 120 may be utilized to operate the pump/motor 104 (see directional arrow 170 in FIG. 3) to charge the accumulator 124 (see directional arrow 166) from junction A (see directional arrow 168). Referring to FIG. 2, the pump/motor 104, operated by the engine 120, may pump fluid from the tank 74 via line 148 and 138 to charge the accumulator 124.

Conversely, when additional power is required by the engine 120 and the accumulator 124 is sufficiently charged, the pump/motor 104 may be utilized in peak charging operation. In other words, the pump/motor 104 may act as a motor, fluid from the accumulator 124 operating the pump/motor 104 (see directional arrow 160 in FIG. 3) to supply power to the engine 120 (see directional arrow 186) as fluid moves from the accumulator 124 through the pump/motor 104 to the tank 74 (see directional arrow 172). In other words, referring to the embodiment of FIG. 2, the accumulator 124 directly discharges via line 134 to operate the pump/motor 104 as fluid is supplied through open through line 152 to open valve 150 and on to the tank 74. It will be appreciated that pressure sensor 142 may be configured to provide a signal to the controller 51 in order to determine when such operation is appropriate.

Thus, referring to FIG. 3, pump/motor 104 is connected to engine 120, as indicated by directional arrows 170 and 186. This coupling may improve engine efficiency significantly. In other words, if the inlet hydraulic power of pump/motor 104 is greater than its outlet hydraulic power, the pump/motor 104 provides power back to engine 120, and vice versa.

Embodiments of the disclosed multi-function hydraulic hybrid swing circuit 50 may be applicable to any excavation machine that performs a substantially repetitive work cycle, which involves swinging movements of a work tool.

Embodiments of the multi-function hydraulic hybrid swing circuit 50 for recovering and reusing kinetic energy from swing motor 49 deceleration may perform both open loop and closed loop swing, and conduct machine power peak-shaving operation. Some embodiments may utilize pump/motor-in-loop accumulator charge, which may significantly improve power density of accumulator 124 as well as controllability and energy recovery efficiency during swing deceleration.

Embodiments of the multi-function hydraulic hybrid swing circuit 50 may optimize features of operational modes to provide enhanced swing performance, as well as machine power management efficiency. In some embodiments, the implementation of the pump/motor 104 in a loop for charging of the accumulator 124 may improve power density of the accumulator 124, as well as enhance controllability and energy recovery efficiency during swing deceleration.

Ultimately, some embodiments may improve machine productivity. Some embodiments may provide increases fuel efficiency over prior art arrangements.

Some embodiments may facilitate a reduction in engine 120 size over prior art arrangements.

Some disclosed embodiments may provide compact packaging that may be appropriate for use in machines 10 including size limitations or smaller platforms.

Some embodiments may be particularly effective in excavators, shovels and other construction, mining, forest equipments with a swing sub-system.

We claim:

1. A multi-function hydraulic hybrid swing circuit for movement of fluid, the multi-function hydraulic hybrid swing circuit comprising:
a fluid source,
a swing circuit,
a swing supply circuit, the swing supply circuit including
at least one accumulator,
a pump/motor operatively connected to a power source, the pump/motor fluidly connected to the swing circuit, the accumulator, and the fluid source,
at least one accumulator valve regulating flow between the accumulator and the pump/motor,
at least one drain valve regulating flow between the fluid source and the pump/motor, and
at least one valve regulating flow between the pump/motor and the swing control valve,
wherein the pump/motor is configured to provide closed loop operation with the swing circuit, the pump/motor circulating fluid through the swing circuit, and
wherein the pump/motor is configured to provide open loop operation with the swing circuit.

2. The multi-function hydraulic hybrid swing circuit of claim 1 further comprising a controller configured to provide signals to control operation of a plurality of said valves to configure the pump/motor to perform the open loop and closed loop operations.

3. The multi-function hydraulic hybrid swing circuit of claim 1 wherein the pump/motor is configured to provide open loop operation with the swing circuit, pump/motor pumping fluid from the fluid source to the swing circuit.

4. The multi-function hydraulic hybrid swing circuit of claim 1 wherein the pump/motor is configured to provide open loop operation with the swing circuit, the pump/motor pumping fluid from the accumulator to the swing circuit.

5. The multi-function hydraulic hybrid swing circuit of claim 3 wherein the pump/motor is configured to provide open loop operation with the swing circuit, the pump/motor pumping fluid from the accumulator to the swing circuit.

6. The multi-function hydraulic hybrid swing circuit of claim 1 wherein the pump/motor is configured to pump fluid from the fluid source to the accumulator during a peak charging operation.

7. The multi-function hydraulic hybrid swing circuit of claim 1 wherein the pump/motor is configured to receive fluid from the accumulator and operate as a motor providing power to the power source during a peak shaving operation.

8. The multi-function hydraulic hybrid swing circuit of claim 1 further comprising an implement pump fluidly coupled to other circuits and to the swing circuit, the implement pump being configured to provide fluid to the swing circuit, the pump/motor being fluidly coupled to other circuits, the pump/motor being configured to provide fluid to the other circuits.

9. The multi-function hydraulic hybrid swing circuit of claim 5 wherein the pump/motor is configured to pump fluid from the fluid source to the accumulator during a peak charging operation, and the pump/motor is configured to receive fluid from the accumulator and operate as a motor providing power to the power source during peak shaving operation.

10. A machine comprising
a frame,
an undercarriage member, the frame being rotatably coupled to the undercarriage member along a vertical axis,
an implement system coupled to the frame,
a fluid source including a tank,
fluid,
a multi-function hydraulic hybrid swing circuit for movement of fluid, the multi-function hydraulic hybrid swing circuit including
a swing circuit,
a swing supply circuit, the swing supply circuit including
at least one accumulator,
a pump/motor operatively connected to a power source, the pump/motor fluidly connected to the swing circuit, the accumulator, and the fluid source,
at least one accumulator valve regulating flow between the accumulator and the pump/motor,
at least one drain valve regulating flow between the fluid source and the pump/motor, and
at least one valve regulating flow between the pump/motor and the swing circuit,
wherein the pump/motor is configured to provide closed loop operation with the swing circuit, the pump/motor circulating fluid through the swing circuit, and
wherein the pump/motor is configured to provide open loop operation with the swing circuit.

11. The machine of claim 10 further comprising a controller configured to provide signals to control operation of a plurality of said valves to configure the pump/motor to perform the open loop and closed loop operations.

12. The machine 10 wherein the pump/motor is configured to provide open loop operation with the swing circuit, pump/motor pumping fluid from the fluid source to the swing circuit, and configured to provide open loop operation with the swing circuit, the pump/motor pumping fluid from the accumulator to the swing circuit.

13. The machine of claim 10 wherein the pump/motor is configured to pump fluid from the fluid source to the accumulator during a peak charging operation.

14. The machine of claim 10 wherein the pump/motor is configured to receive fluid from at least one of the accumulator and the swing circuit and operate as a motor providing power to the power source during a peak shaving operation.

15. The machine of claim 10 further comprising an implement pump fluidly coupled to the implement system and to the swing circuit, the implement pump being configured to provide fluid to the swing circuit, the pump/motor being fluidly coupled to the implement system, the pump/motor being configured to provide fluid to the implement system.

16. The multi-function hydraulic hybrid swing circuit of claim 12 wherein the pump/motor is configured to pump fluid from the fluid source to the accumulator during a peak charging operation, and the pump/motor is configured to receive fluid from the accumulator and operate as a motor providing power to the power source during peak shaving operation.

17. A method of operating a multi-function hydraulic hybrid swing circuit for movement of fluid, the multi-function hydraulic hybrid swing circuit including a swing circuit, a swing supply circuit, and a fluid source including a tank, the swing supply circuit including at least one accumulator, a pump/motor operatively connected to a power source, the pump/motor fluidly connected to the swing circuit, the accumulator, and the fluid source, and at least one accumulator valve regulating flow between the accumulator and the pump/motor, at least one drain valve regulating flow between the fluid source and the pump/motor, and at least one valve regulating flow between the pump/motor and the swing circuit, a method comprising
operating the pump/motor to provide closed loop operation with the swing circuit, the pump/motor circulating fluid through the swing circuit, and
operating the pump/motor to provide open loop operation with the swing circuit.

18. The method of claim 17 wherein operating the pump/motor to provide open loop operation with the swing circuit includes the pump/motor pumping fluid from the fluid source to the swing circuit, and the pump/motor pumping fluid from the accumulator to the swing circuit.

19. The method of claim 17 wherein operating the pump/motor to provide at least one peak shaving operation includes the pump/motor pumping fluid from the fluid source to the accumulator during a peak charging operation, and the pump/motor receive fluid from the accumulator and operate as a motor providing power to the power source during a peak shaving operation.

20. The method of claim 17 wherein operating the pump/motor to provide at least one peak shaving operation includes the pump/motor pumping fluid from the fluid source to the accumulator during a peak charging operation, and the pump/motor receive fluid from the accumulator and operate as a motor providing power to the power source during a peak shaving operation.
